(19) United States
(12) Patent Application Publication
(10) Pub. No.: US 2015/0130896 A1
(43) Pub. Date: May 14, 2015

(54) LIGHT REDIRECTION HOLOGRAM FOR REFLECTIVE DISPLAYS

(71) Applicant: QUALCOMM MEMS Technologies, Inc., San Diego, CA (US)

(72) Inventors: Jian Ma, Carlsbad, CA (US); Kebin Li, Fremont, CA (US); John Hyunchul Hong, San Clemente, CA (US); Tallis Young Chang, San Diego, CA (US)

(73) Assignee: QUALCOMM MEMS Technologies, Inc., San Diego, CA (US)

(21) Appl. No.: 14/272,913

(22) Filed: May 8, 2014

Related U.S. Application Data
(60) Provisional application No. 61/901,970, filed on Nov. 8, 2013.

(51) Int. Cl. G03H 1/00; G03H 1/20; G02B 5/02

(52) U.S. Cl. CPC G03H 1/0005; G02B 5/0252; G03H 1/20; G03H 2001/0077; G03H 2001/0088
USPC 348/40; 359/15; 430/2

(57) ABSTRACT

This disclosure provides systems, methods and apparatus for enhancing the brightness and/or contrast ratio of display devices. In one aspect, the display devices can include a light redirector that is optically coupled with a diffuser. The light redirector includes a plurality of holographic features that can receive near-collimated light at non-normal angles with respect to a normal to a surface of the light redirector and redirects the received light along a direction that is substantially normal to the surface.

### CROSS-REFERENCE TO RELATED APPLICATIONS

This disclosure claims priority to U.S. Provisional Patent Application No. 61/901,970, filed Nov. 8, 2013, entitled “LIGHT REDIRECTION HOLOGRAM FOR REFLECTIVE DISPLAYS,” and assigned to the assignee hereof. The disclosure of the prior application is considered part of, and is incorporated by reference in, this disclosure.

### TECHNICAL FIELD

This disclosure relates to diffusers and more particularly to holographic diffusers that can shift the viewing angle away from the direction of specular reflection associated with the direction from which light is incident. The diffusers disclosed herein can be integrated with electromechanical systems based display devices.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). The term IMOD or interferometric light modulator refers to a device that selectively absorbs and/or reflects light using the principles of optical interference. In some implementations, an IMOD display element may include a pair of conductive plates, one or both of which may be transparent and/or reflective, wholly or in part, and capable of relative motion upon application of an appropriate electrical signal. For example, one plate may include a stationary layer deposited over, on or supported by a substrate and the other plate may include a reflective membrane separated from the stationary layer by an air gap. The position of one plate in relation to another can change the optical interference of light incident on the IMOD display element. IMOD-based display devices have a wide range of applications, and are anticipated to be used in improving existing products and creating new products, especially those with display capabilities.

The brightest viewing angle in various display devices often coincides with the direction along which incident light is specularly reflected from the different parts of the display device (for example, display elements, cover glass, etc.). Various systems and methods have been developed to reduce glare from specularly reflected incident light to enhance brightness of the display device.

### SUMMARY

The systems, methods and devices of the disclosure each have several innovative aspects, no single one of which is solely responsible for the desirable attributes disclosed herein.

One innovative aspect of the subject matter described in this disclosure can be implemented in a light redirector. The light redirector comprises a light receiving surface having a surface normal that is configured to receive near-collimated light from an incidence direction that is at an angle with respect to the surface normal. A direction of specular reflection is associated with the incidence direction. The incidence direction can form an angle between about 20 degrees and about 50 degrees with respect to the surface normal.

The light redirector further comprises a holographic layer including a plurality of transmissive holographic light redirecting features that are configured to redirect and diffuse the received light substantially along a direction that is within ±20 degrees with respect to the surface normal towards a side opposite the light receiving surface. In various implementations, the plurality of holographic light redirecting features can include volume holograms. The holographic layer can have a thickness between about 5 μm and about 50 μm. In various implementations, the plurality of holographic light redirecting features can be configured such that light incident from the side opposite to the light receiving surface in an angular range that is within ±10 degrees with respect to the surface normal is not redirected by the plurality of holographic light redirecting features.

The light director can be included in a display device including a reflective display element. In various implementations, the light redirector can be disposed over the reflective display element. The reflective display element can include at least one interferometric modulator. In various implementations, the reflective display element can be disposed on a first side of a substrate and the light redirector can be disposed on a second side of the substrate opposite the first side.

In various implementations, the holographic layer can function as a light redirector and a light diffuser. The holographic layer can be a single optical element that is a light redirector and a light diffuser.

Another innovative aspect of the subject matter described in this disclosure can be implemented in a light redirector comprising a light receiving surface having a surface normal and configured to receive near-collimated light from an incidence direction that is at an angle with respect to the surface normal. A direction of specular reflection is associated with the incidence direction.

The light redirector further comprises a layer including a plurality of transmissive means for holographically redirecting light. The transmissive light redirecting means are configured to redirect and diffuse the received light substantially along a direction that is within ±20 degrees with respect to the surface normal towards a side opposite the light receiving surface.

In various implementations, the plurality of transmissive light redirecting means can include a plurality of transmissive holographic features. The transmissive holographic features can include volume holograms. In various implementations, the layer can be a single optical element that is a light redirector and a light diffuser.

Another innovative aspect of the subject matter described in this disclosure can be implemented in a method of manufacturing a light redirector. The method comprises providing a substrate including a light receiving surface having a surface normal that is configured to receive near-collimated light from an incidence direction that is at an angle with respect to the surface normal. A direction of specular reflection is associated with the incidence direction. The method further comprises disposing a plurality of transmissive holographic light redirecting features with respect to the substrate. The plurality of transmissive holographic light redirecting features is configured to redirect and diffuse the received light substantially along a direction that is within ±20 degrees with respect to the surface normal towards a side opposite the light receiving surface.

In various implementations of the method, disposing a plurality of transmissive holographic light redirecting features can further comprise disposing a first holographic medium forward or rearward of the light receiving surface and forming the plurality of transmissive holographic features in the first holographic medium.

The first holographic medium can include a photopolymer. The plurality of transmissive holographic features can be formed by replicating a plurality of holographic features included in a master hologram on the first holographic medium using a single coherent multi-wavelength laser beam. The master hologram including the plurality of holographic features can be recorded using two coherent laser beams incident on a second holographic medium, the two beams including multiple wavelengths in blue, green and red spectral regions. In various implementations of the method, a diffuser can be disposed in the optical path of one of the two beams. The plurality of holographic light redirecting features can be recorded with one of the coherent laser beams being incident on the second holographic medium at different azimuthal angles.

Details of one or more implementations of the subject matter described in this disclosure are set forth in the accompanying drawings and the description below. Although the examples provided in this disclosure are primarily described in terms of EMS and MEMS-based displays the concepts provided herein may apply to other types of displays such as liquid crystal displays, organic light-emitting diode (“OLED”) displays, and field emission displays. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 illustrates an implementation of a reflective display device with light incident from an incidence direction being reflected along a direction of specular reflection that is associated with the incidence direction.

FIG. 2 illustrates the reflectance and contrast ratio of an implementation of a reflective display device as a function of the viewing angle.

FIG. 3 depicts the variation of intensity of diffused light as a function of view angle for four kinds of diffusers.

FIG. 4A illustrates an implementation of a display device including a display element, a light redirector and a diffuser.

FIG. 4B illustrates the effect of the light redirector on incident ambient light.

FIG. 4C illustrates effect of the light redirector on light reflected from surfaces of the display element.

FIG. 5 illustrates the diffraction efficiency of a holographic volume grating as a function of angular deviation from Bragg condition.

FIG. 6 illustrates an implementation of a display device including two holograms that are configured to receive and redirect light incident from two different incoming directions.

FIG. 7 illustrates the diffraction efficiency of a volume grating as a function of wavelength deviation from Bragg condition.

FIG. 8 illustrates an implementation of a display device including a holographic optical element disposed forward of a display element.

FIG. 9A illustrates a system that can be used to record holographic light redirectors that also function as a diffuser.

FIG. 9B is a flowchart that describes an implementation of a method of manufacturing a light redirector including a plurality of transmissive holographic light redirecting features.

FIG. 9C is a flowchart that describes an implementation of a method of forming a plurality of transmissive holographic light redirecting features in a holographic medium.

FIG. 10A illustrates an implementation of a display panel illuminated by a fluorescent light. FIG. 10B illustrates an image displayed by the display panel provided with holographic light redirectors optically coupled to a diffuser or a single holographic optical element that can redirect and diffuse light. FIG. 10C illustrates an image displayed by the display panel provided with a conventional diffuser with a haze value of 78.

FIG. 11 is an isometric view illustration depicting two adjacent interferometric modulator (IMOD) display elements in a series or array of display elements of an IMOD display device.

FIGS. 12A and 12B are system block diagrams illustrating a display device that includes a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Systems and methods described herein include a light redirector that is configured to receive near-collimated light (e.g., sunlight on a clear day or light from a light source in a room that is otherwise poorly illuminated) incident on a light receiving surface of the light redirector at a non-zero angle with respect to a normal to the light receiving surface and redirect the received light. The light redirector is configured to redirect the near-collimated incident light such that it propagates rearward of the light redirector along a direction that is substantially normal to the light receiving surface towards a reflective display device. A diffuser (e.g., a phase diffuser) can be disposed rearward of the light redirector and forward of the display device to diffuse light redirected from the light redirector. The presence of the diffuser advantageously randomizes the phase of light reflected from the display device such that most of the light reflected from the display device does not interact with the holographic light redirector. In various implementations, the light redirector can be configured to diffuse the redirected light such that a separate diffuser is not provided. In various implementations, the light redirector includes volume holograms that are configured to redirect and diffuse incident near-collimated light. In various implementations, the light redirector includes several angle multiplexed volume holograms that can redirect and diffuse the incident near-collimated light from several different azimuthal angles. In various implementations, the near-collimated light can be white light including red, green and blue wavelengths. In some implementations, the holographic light redirector is recorded at multiple wavelengths (e.g., red, green, blue). In some implementations, the diffraction efficiency of the red, green and blue holograms can be the same. However, in other implementations, the diffraction efficiency of the red, green and blue holograms can be different for compensating color errors from the reflective displays.

Particular implementations of the subject matter described in this disclosure can be used to realize one or more of the following potential advantages. Various implementations of a display device including a holographic light redirector optically coupled to a diffuser or a single holographic optical element that can redirect and diffuse light can be used to redirect and diffuse near-collimated light incident at non-normal angles such that coincidence between the direction of propagation of the modulated light from the display device and the direction of propagation of light specularly reflected from various parts of the display device (for example, the display cover, touch layer and other display layers, etc.) can be reduced or eliminated. This in turn can reduce, mitigate and/or eliminate glare from the incident light that is specularly reflected from surfaces of different parts of the display device. Furthermore, by redirecting light normal to the reflective display using the holographic light redirector, the reflective display can use ambient light more efficiently. Additionally, by directing the modulated light away from the direction along which light is specularly reflected, brightness and/or contrast ratio of the display can be increased (as compared to devices without such a holographic light redirector optically coupled to a diffuser or a single holographic optical element that can redirect and diffuse light). Reducing or eliminating the coincidence between the direction of propagation of the modulated light from the display device and the direction of propagation of light specularly reflected from various parts of the display device can also improve the color saturation of the display colors. Most importantly, various implementations of a display device including a holographic light redirector optically coupled to a diffuser or a single holographic optical element that can redirect and diffuse light allows viewer to see the display at an angle normal to the display surface when direct illumination is at angle angle, and as a result, it reduces or eliminates display color shift associated with viewing angle.

An example of a suitable EMS or MEMS device or apparatus, to which the described implementations may apply, is a reflective display device. Reflective display devices can incorporate interferometric modulator (IMOD) display elements that can be implemented to selectively absorb and/or reflect light incident thereon using principles of optical interference. IMOD display elements can include a partial optical absorber, a reflector that is movable with respect to the absorber, and an optical resonant cavity defined between the absorber and the reflector. In some implementations, the reflector can be moved to two or more different positions, which can change the size of the optical resonant cavity and thereby affect the reflectance spectrum of the IMOD. The reflectance spectra of IMOD display elements can create fairly broad spectral bands that can be shifted across the visible wavelengths to generate different colors. The position of the spectral band can be adjusted by changing the thickness of the optical resonant cavity. One way of changing the optical resonant cavity is by changing the position of the reflector with respect to the absorber.

Display devices including a plurality of reflective display elements similar to the devices described above can rely on ambient lighting in daylight or well-lit environments for illuminating the display elements. In addition, an internal source of illumination (for example, a front illuminator) can be provided for illuminating the display elements in dark ambient environments. Directional ambient light can be specularly reflected from various parts of the display device. For example, the light incident on the display device can be specularly reflected by the display cover. In some implementations, the viewing direction in which the modulated light is brightest can substantially coincide with the direction in which light is specularly reflected. The glare resulting from the specularly reflected light can affect the brightness or the contrast ratio of the modulated light.

Accordingly, a diffuser can be used in display devices to shift the direction of propagation of the light modulated by the display elements away from the direction in which the incident light is specularly reflected and/or for increasing the viewing angle. However, in some implementations of the diffuser, the brightest viewing angle can coincide with the specular reflection from cover glass and other layers of the display elements. Although an antireflection coating together with a diffuser can greatly reduce the specular glare in such implementations, the residual glare can considerably degrade the contrast ratio and de-saturate the colors. The effect of specular glare can be reduced when the viewing angle is shifted by more than 15 degrees away from specular angle. The implementations described herein include holographic light redirectors optically coupled to diffusers or a single holographic optical element that can redirect and diffuse light to redirect and diffuse near-collimated incident at non-normal angles to reduce or eliminate the coincidence between the direction of propagation of the modulated light from the display device and the direction of propagation of light specularly reflected from various parts of the display device to reduce, mitigate and/or eliminate glare from the incident light that is specularly reflected from various portions of the display device not limited to the display cover, the touch panel and any other partially reflecting surfaces or interfaces of the display device that are located above the hologram.

FIG. 1 illustrates an implementation of a reflective display device 100 with light incident from an incidence direction 107 being reflected along a direction of specular reflection 109 that is associated with the incidence direction 107. For example, from geometrical optics the direction of specular reflection 109 can be associated with the incidence direction 107 such that, relative to surface normal 108, the angle of incidence θᵢ is equal to the angle of reflection θᵣ. The reflective display device 100 illustrated in FIG. 1 includes a plurality of reflective display pixels 101 disposed rearward of a substrate 103. The display pixels 101 can include various implementations of the interferometric modulators discussed above. The display device 100 includes a diffuser 105 disposed forward of the substrate 103. The display device can further include additional layers such as a display cover, one or more optical filters, anti-reflection layers, and/or other optical layers.

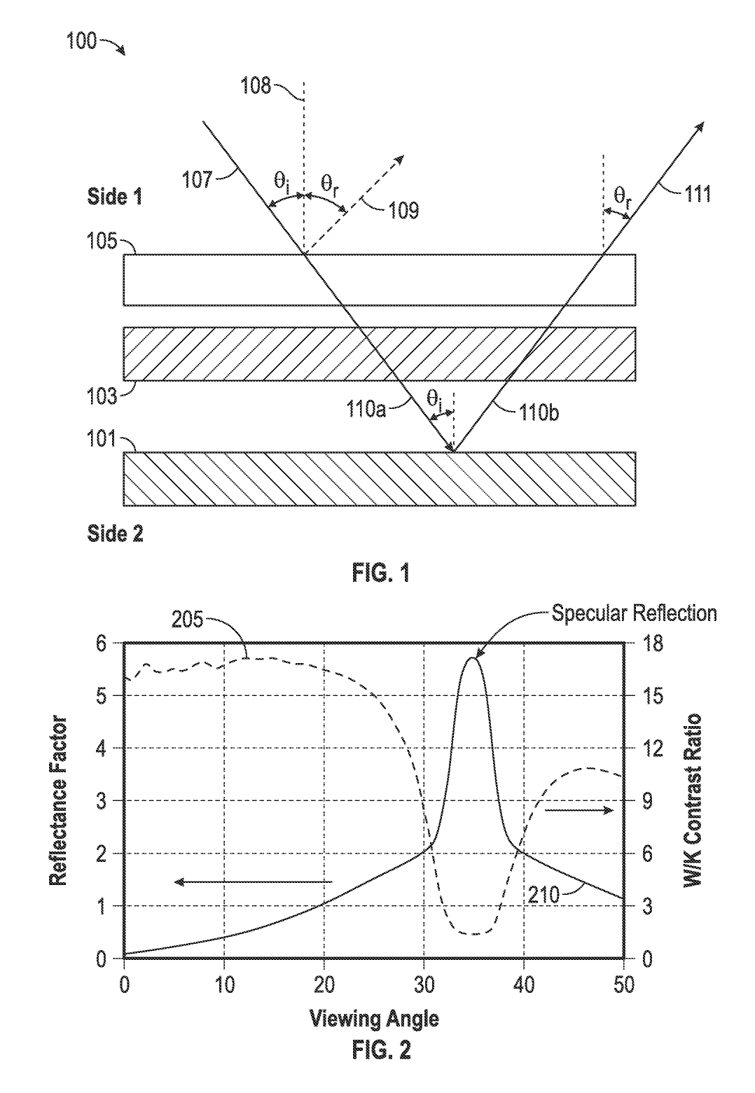

The display device 100 has a front side (side 1 of FIG. 1) and a back side (side 2 of FIG. 1). A portion of the light from a source disposed on the front side of the display device 100 that is incident along the incidence direction 107 can be specularly reflected by various parts of the display device 100 (for example, the reflective display elements 101 and/or the plurality of layers 103 and 105) along the direction of specular reflection 109. A portion of the light, represented by ray 110a, is modulated by the display device 100 and reflected towards the front side of the display device, as represented by ray 110b. It is then diffused by the diffuser 105. In various implementations, a large portion of the modulated light is reflected and diffused along a direction 111 which is along the same direction of specular reflection 109 as shown in FIG. 1. The conventional diffuser and consequently the display device 100 can have a maximum forward scattering along the direction of specular reflection 109 such that the display device 100 appears the brightest when viewed along the direction of specular reflection 109. However, light which is specularly reflected from the upper layers of the device can degrade the contrast ratio of the display device 100 as discussed below with reference to FIG. 2.

FIG. 2 illustrates the reflectance and contrast ratio of an implementation of a reflective display device as a function of the viewing angle. In the illustrated implementations direct light is incident from the left of a normal to a surface of the display device at approximately −35 degrees with respect to the normal. The reflective display device can be similar to the reflective display device 100 discussed above that includes a conventional diffuser. The viewing angle can be measured relative to a normal to the front surface of the display device (for example, the normal 108 shown in FIG. 1). Reflectance of the reflective display device is indicated by the reflectance curve 210. The reflectance curve 210 can provide a measure of the amount of light when the reflective display device is viewed at various viewing angles and can be obtained by measuring the amount of light reflected and scattered by the reflective display device that has a conventional diffuser along different directions. In FIG. 2, the amount of light reflected by the reflective display device was measured when the reflective display device was set at the white state to obtain the reflectance curve 210. Contrast ratio of the display device is indicated by curve 205. In various implementations, the contrast ratio curve 205 can be obtained by determining a ratio of the brightest color (for example, white) and the darkest color (for example, black) as the reflective display device is viewed along different viewing angles.

In FIG. 2, the peak of the reflectance curve 210 coincides with the specular reflection angle of the display, i.e., 35 degree with respect to the display normal. Also, the peak of the reflectance curve 210 coincides with the angle at which the contrast ratio curve 205 decreases to a minimum. This effect can be partly attributed to the coincidence of the peak of the reflectance curve 210 with the specular reflection angle, because the specularly reflected light combines with the light modulated by the display device and increases the luminance of the black state, and as a result, it reduces the contrast of the image produced by the display device. It is also observed from FIG. 2 that the peak of the contrast ratio curve 205 occurs when the reflective display device is viewed from an angle of between approximately 0 degrees with respect to the normal to the front surface of the display device and approximately 20 to 25 degrees with respect to the normal to front the surface of the display device. The peak in the contrast ratio curve 205 can be attributed partially to the reduction in the specular reflectance from the display device as observed from the reflectance curve 210. It can be generally inferred from the example reflectance and contrast curves 210 and 205 in FIG. 2 that the contrast ratio of the display device decreases when the viewing angle is closer to the specular angle which can be attributed to an increase in the specular reflectance of the display device. Thus, when the viewing angle of the display device coincides with the direction along which incident light is specularly reflected, the contrast ratio of the display device can degrade significantly. Accordingly, it is desirable to shift the viewing angle of the display away from the direction of specular reflection in order to reduce the glare due to specular reflection such that the display device can be viewed along a direction which corresponds to the maximum brightness without degraging the contrast ratio.

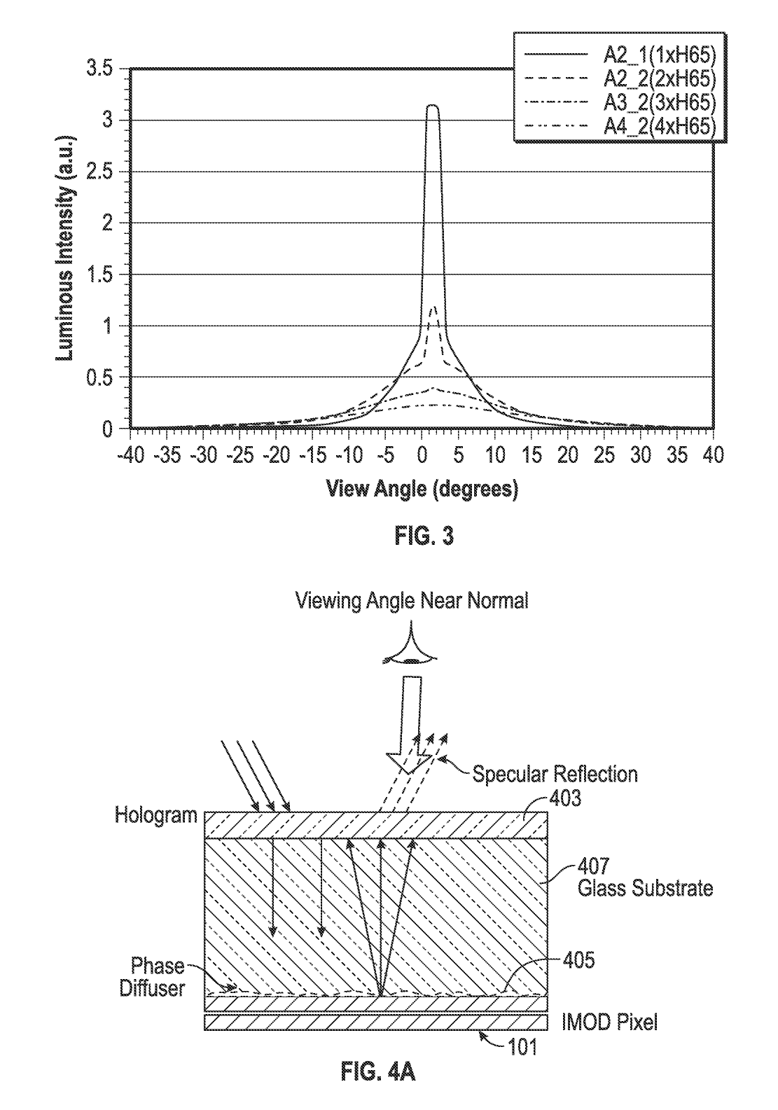

From FIG. 2, it is noted that shifting the viewing angle by approximately 15 degrees away from the direction of specular reflection can reduce glare from specular reflection. As discussed above, various implementations of a reflective display device can include diffusers that can shift the viewing angle away from the direction of specular reflection. In various implementations, the display device provided with a conventional diffuser can include antireflection coatings to reduce specular reflection. However, conventional diffusers typically scatter incoming light in a cone-like region that includes and surrounds the direction along which light is specularly reflected as discussed in detail with reference to FIG. 3.

FIG. 3 depicts the variation of intensity of diffused light as a function of view angle for four kinds of diffusers. As observed from FIG. 3, the conventional diffusers scatter incoming light in a region having an angular width of about 10 degrees or less with respect to a normal viewing direction corresponding to a view angle of zero degrees which includes and surrounds the direction along which light is specularly reflected. Accordingly, significant optical power remains near direction along which light is specularly reflected. Although antireflection coatings can be provided to reduce the specular glare to a small degree, residual glare of the specularly reflected light can degrade the contrast ratio and/or desaturate colors displayed by the device.

Therefore, instead of using conventional diffusers, the display device can include one or more layers that are configured to shift the direction along which the light reflected from the display device (e.g., modulated light) is directed away from the direction of the specular reflection. When the device is viewed from such a “shifted” direction, preferably the normal direction, specularly reflected light may contribute insubstantially to the light perceived by the viewer, thereby reducing or eliminating glare from specular reflection. In such implementations, since the viewing angle along which the display appears the brightest does not coincide with the direction along which the light is specularly reflected, the display device can be optimized to provide enhanced brightness, increased contrast ratio, improved color saturation, and eliminated color shift. In various implementations, it may be advantageous if the direction along which light reflected from the display device (e.g., modulated light) is shifted by an angle in a range from about 20 degrees to about 50 degrees away from the direction of the specular reflection, and is preferably normal to the display surface. This can advantageously reduce the amount of modulated light that is scattered in the direction of specular reflection and/or increase the brightness and contrast ratio of the display device, and to eliminate color angle shift. In various implementations, modulated light is directed in a cone which has an angular width of about 5 degrees with respect to a normal to a surface of the display device. In various implementations, the light reflected from the display can be directed in a cone shaped regions that has a semi vertical angle that is approximately equal to a desired design angle. In various implementations, instead of providing a separate diffuser, the diffusing function can be incorporated in the light redirector. Incorporating diffuse function into the light redirector combines two functions—light redirecting and diffusion—into a single optical element; thereby simplifying the device structure and reducing visual artifacts.

To provide the shifted viewing direction, various implementations described herein include a diffuser that is optically coupled with a light redirector. The light redirector is configured to receive near-collimated light incident on a light receiving surface of the light redirector at a non-zero angle with respect to a normal to the light receiving surface and redirect the received light. The light redirector is configured to redirect the near-collimated incident light such that it propagates rearward of the light redirector along a direction that is substantially normal to the light receiving surface towards a display device. In various implementations, the light redirector can include holographic light redirecting features. In various implementations, the diffuser can be incorporated in the light redirector. In various implementations, the light redirector can be a holographic diffuser. These and other features are described in further detail below.

Holographic light redirectors optically coupled to a diffuser or a single holographic optical element that can redirect and diffuse light can be used to redirect light reflected from the display device away from the direction of specular reflection. Holographic light redirectors optically coupled to a diffuser or a single holographic optical element that can redirect and diffuse light can be used to steer light reflected from the display along a direction that is more normal to the surface of the display device thereby providing increased contrast ration. Since, holographic light redirectors optically coupled to a diffuser or a single holographic optical element that can redirect and diffuse light can steer light reflected from the display along a direction that is more normal to the surface of the display device, they can advantageously reduce or eliminate color shift (e.g., blue shift) of the light reflected from the display device when the display device is viewed at an angle. When the display is viewed at an angle θ to the display normal, the perceived wavelength λ is shifted from the designed wavelength λₒ. In various implementations, the perceived wavelength λ can be given by the equation λₒ cos θ. As noted from FIG. 2, with a conventional diffuser, the optimum viewing angle that has low contribution from specular reflection and high contrast ratio is between 0 degrees to about 20 degrees from the normal. When viewed at an angle of about 20 degrees, the perceived wavelength λ can be shifted by a factor of)cos(20° which is about 0.94. This amount of shift can be significant and easily discernible by human eyes. By using a holographic light redirector that redirects the incident light along a normal or near normal direction, a display device can be illuminated at normal direction or a near normal direction. Accordingly, light reflected from the display device will also be directed along a normal or near normal direction such that the viewing angle is close to zero degrees. Thus, color shift can be eliminated with the use of a holographic light redirector

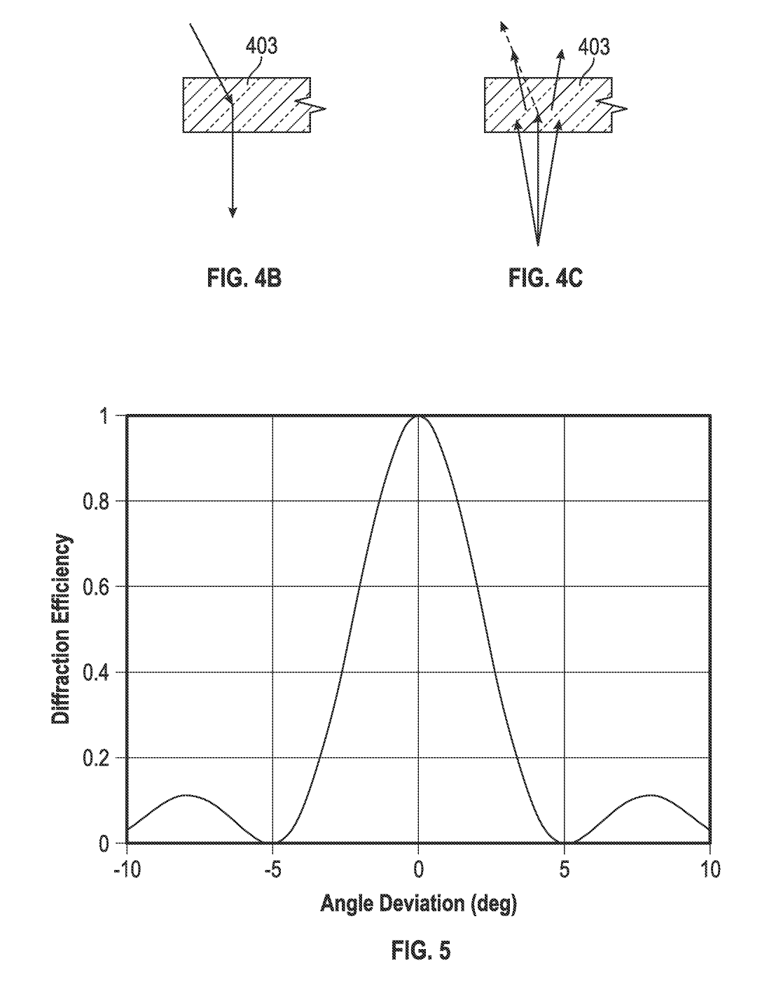

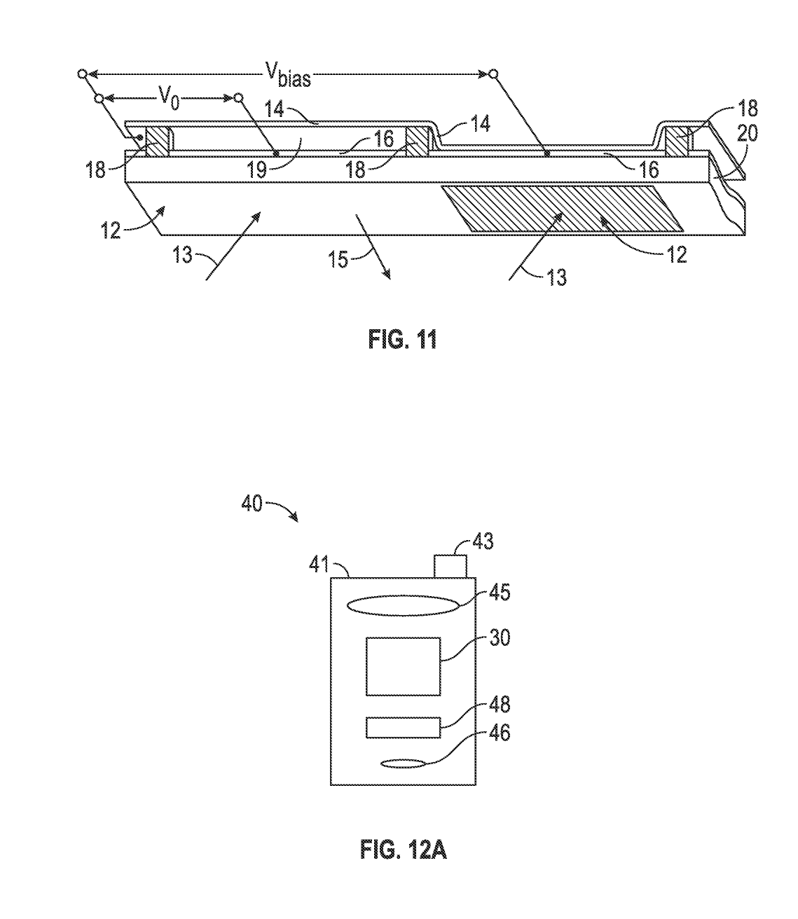

FIG. 4A illustrates an implementation of a display device including a display element 101, a light redirector 403 and a diffuser 405. The display element 101 is disposed on a first side of a substrate 407. The diffuser 405 is disposed on the first side of the substrate 407 and the light redirector 403 is disposed on a second side of the substrate 407 such that the light redirector 403 and the diffuser 405 are on opposite sides of the substrate 407. In various implementations, the display element 101 can be reflective. In various implementations, the display element 101 can be an electro-mechanical systems based device such as an IMOD described below with reference to FIG. 11. In some implementations, the display element 101 can include a LCD device. In some implementations, the display element 101 can include an electro-phoretic device. The substrate 407 includes a transmissive material that transmits light. For example, the substrate 407 can include glass, plastic, polymer, etc. In various implementations, the light redirector 403 can be a holographic light redirector including one or more holographic features. In various implementations, the holographic features can be volume holograms. For example, in some implementations, multiple holograms can be superimposed in a volume holographic medium (e.g., ˜20 um thick holographic photopolymer film). In various implementations, the diffuser 405 can be a phase diffuser that randomizes the optical phase of incoming radiation that is incident on the display element 101. In some implementations, the diffuser 405 can include micron and submicron pixels with phase distribution designed to create a desired diffuse angular distribution. In some implementations, the diffuser 405 can be disposed in close proximity with the display element 101. The arrangement of diffuser 405 disposed in close proximity to the display element 101 can reduce or eliminate image blurring that can occur when the the diffuser 405 is disposed farther from the display element 101. This can allow the display element 405 to achieve full native pixel resolution. In the implementation illustrated in FIG. 4A, the light redirector 403 is placed at a far distance above the diffuser 405 (e.g., on the other side of the substrate 407). For example, in various implementations, the light redirector 403 can be located in the far field of the diffuser 405. The light redirector 403 in collaboration with the diffuser 405 can increase the brightness when the display is viewed at a near normal direction and reduce glare. The light redirector 403 can redirect incoming light incident on a light receiving surface of the light redirector 403 at non-normal angles along a direction that is substantially normal to the light receiving surface. Accordingly, illumination light from multiple angles can be redirected along a direction that is substantially normal to the display element 101. For example, in various implementations, the light redirector 403 can redirect incoming light incident at an angle between about 20°-50° with respect to the normal to the light receiving surface along a direction that is within ±5° with respect to the normal. The diffuser 405 can diffuse the redirected light before the redirected light being incident on the display device 101. For example, a transmissive diffuser can be employed to achieve this function. An example of providing illumination to the display element 101 using the arrangement illustrated in FIG. 4A is discussed below.

Incoming light (e.g., light from a source such as the sun or a lamp) is redirected by the light redirector 403 to be substantially normal to the display element 101 and made incident on the diffuser 405. The redirected light exits the diffuser 405 and is incident on the display element 101. Light reflected from the display element 101 is further diffused by the diffuser 405 and is incident on the light redirector 403. The wavefront of the light reflected by the display element 101 is modified by the diffuser 405 such that the diffused light reflected from the display element 101 is not a plane wave. Thus, most of the light reflected from the display element 101 does not interact with the holographic features of the light redirector 403 due to Bragg mismatch and will go straight through along a direction that is substantially normal to the display element 101. In this manner, light reflected from the display element 101 is shifted away from the direction of specular reflection. The holographic features in the light redirector 403 can increase the brightness at normal viewing angle by collecting light from multiple angles and by redirecting the peak of the diffused light reflected from the display element away from the direction of specular reflection. In various implementations, the incident light can be collimated or nearly collimated. For example, the incident light can be sunlight incident on the display device on a clear day or light from a light source in a room that is otherwise poorly illuminated and at a distance away from the display.

FIG. 4B illustrates the effect of the light redirector 403 on incident ambient light. FIG. 4C illustrates effect of the light redirector 403 on light reflected from surfaces of the display element 101. In implementations of the holographic light redirector including volume holographic gratings, if light reflected from the display element deviates from the recorded hologram angle (e.g., Bragg angle), it will not “see” or interact with the hologram and exit the hologram “untouched” or unaffected, as illustrated in FIGS. 4B and 4C. Referring to FIGS. 4B and 4C, the Bragg angle is the angle of incidence of ambient light which is a non-normal angle. Since, light reflected from the display element 101 is incident along a direction that is not identically normal to the holographic light redirector 403 and deviates from the Bragg angle, it passes through the holographic light redirector 403 unaffected.

FIG. 5 illustrates the diffraction efficiency of a holographic volume grating as a function of angular deviation from Bragg condition. FIG. 5 is a simulation result of diffraction efficiency versus angle deviation for a 17 μm thick volume holographic grating with a grating refractive index modulation of 0.0145. It is noted from FIG. 5 that when the angle deviation is larger than ±5° from the Bragg condition, the diffraction efficiency becomes very small and the light will not be diffracted. Hence, the diffuser 405 reduces the amount of second-time diffraction by the light redirector 403. Diffused light within an angular region ±5 degrees from normal to a surface of the light redirector 403 and is not identically normal to the surface of the light redirector 403 will not be diffracted by the holographic light redirector 403. From examining the diffused light angle profile illustrated in FIG. 3, it is found that although light in ±5 degree range scattered back from diffuser 405 is diffracted away reciprocally by hologram since they satisfy the Bragg condition, the remainder of the light is propagated along the desired direction. In some implementations, the diffuser function is combined with the hologram during hologram recording by providing a desired diffuser in the optical path of one or both recording laser beams. As such, the Bragg mis-matching condition for the light reflected from the display element 101 can be satisfied automatically in such implementations.

In various implementations, the light redirector 403 can include multiple volume holograms that are configured to redirect light incident from different incoming directions along a direction that is substantially normal to the surface of the light redirector 403. In various implementations, the light redirector 403 can include multiple holograms that can direct light incident along different azimuthal angles. For example, the incident near-collimated light incident at an angle corresponding to the azimuthal angle of 12 o'clock, 10 o'clock (10:30) and 2 o'clock (1:30) positions of the clock as seen when viewing the light receiving surface and an elevation angle of about 45 degrees. This can advantageously redirect the light illumination from multiples angles and enhance the brightness of the display device at a near normal viewing direction.

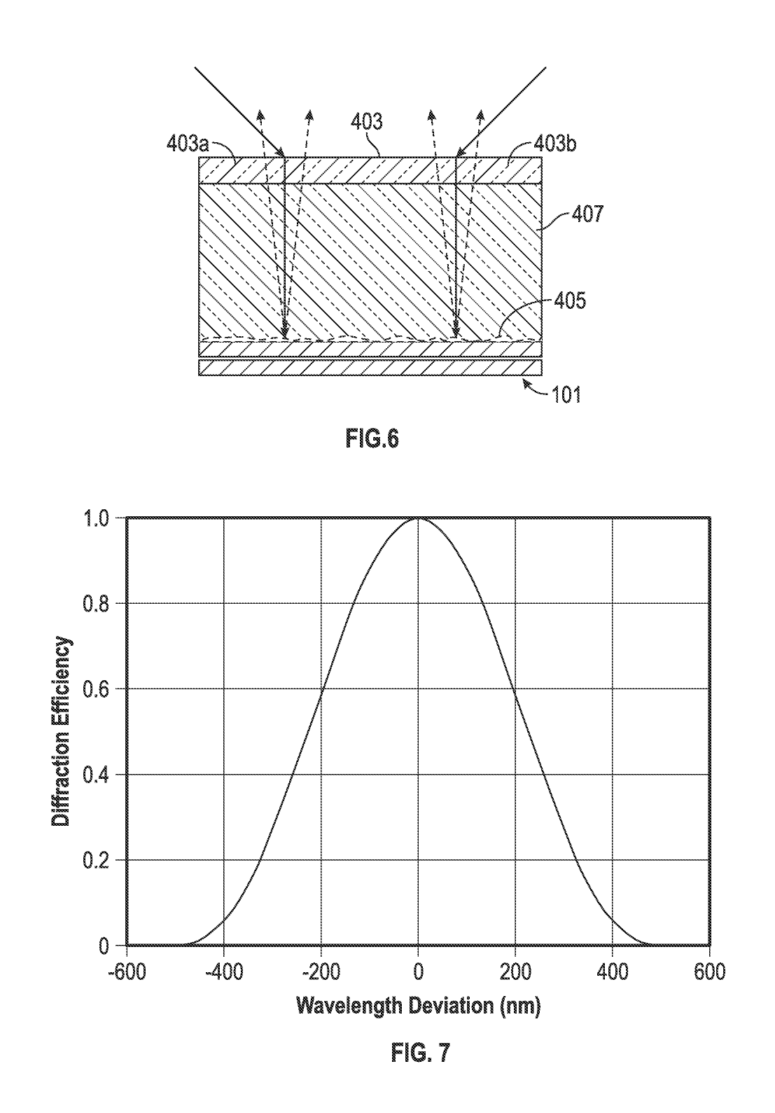

FIG. 6 illustrates an implementation of a display device including two holograms 403a and 403b that are configured to receive and redirect light incident from two different incoming directions. The two holograms 403a and 403b can include volume holograms (e.g., hologram gratings). In various implementations, the two holograms 403a and 403b can be superimposed in a same holographic medium. In some embodiments, the two holograms 403a and 403b can be recorded on different holographic media. In addition to redirecting light incident from two different incoming directions, the two holograms 403a and 403b can include holographic features that are configured to redirect different wavelengths of light. For example, in some implementations, the hologram 403a can be configured to redirect light incident in a first range of wavelengths and the hologram 403b can be configured to redirect light incident in a second range of wavelengths. In some implementations, the first and second range of wavelengths can overlap. However, in other implementations, the first and the second range of wavelengths might not overlap. In yet other implementations, the first and the second range of wavelengths can be the same.

Various implementations of the holographic light redirector can include multiple transmission holograms that are thin. For example, in various implementations, the holograms can be recorded in a holographic layer that has a thickness between about 5 μm and about 50 μm. Since, the holographic layer can be thin, the holographic light redirector can be insensitive to wavelength deviation. FIG. 7 illustrates the diffraction efficiency of a volume grating as a function of wavelength deviation from Bragg condition. FIG. 7 is a simulation result of diffraction efficiency as a function of wavelength deviation for a 17 μm thick volume holographic grating with a grating refractive index modulation of 0.0145. In the simulation, the hologram is considered to be recorded using a green wavelength laser and thus the diffraction efficiency is 100% at green. It is observed from FIG. 7 that the diffraction efficiency drops to about 85% for the blue and red light. A reduction or drop in the diffraction efficiency with variation in the wavelength of light can introduce visual artifacts, such as, for example, rainbow artifacts. To reduce rainbow artifacts, three lasers at red, green, and blue wavelengths can be used to simultaneously record multiple holograms at different wavelengths such that the diffraction efficiency does not vary significantly with wavelength.

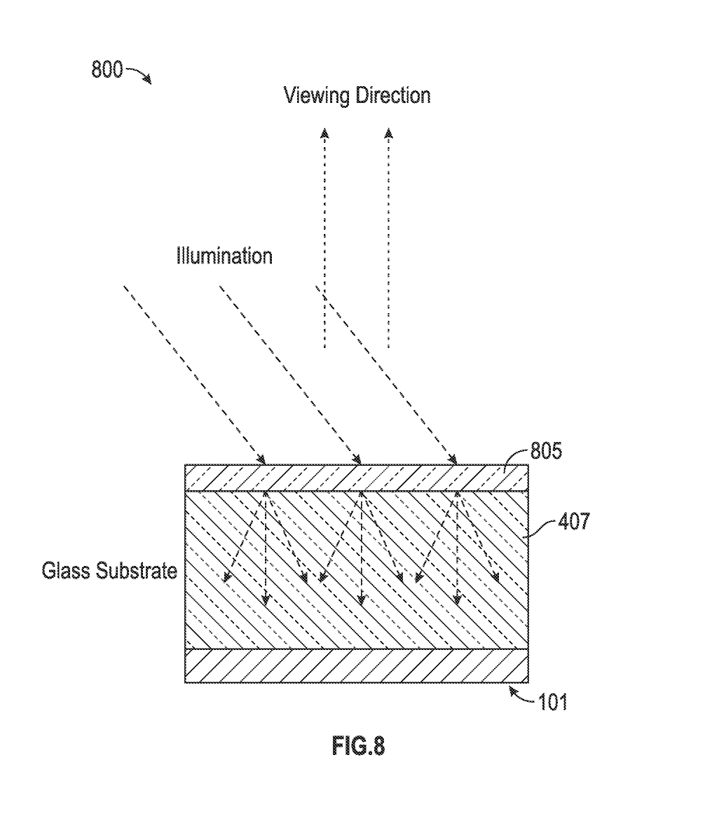

FIG. 8 illustrates an implementation of a display device 800 including a holographic optical element 805 disposed forward of a display element 101. The holographic optical element 805 can be a holographic light redirector integrated with a diffuser. Accordingly, the holographic optical element 805 functions both as a light redirector and as a diffuser. As such, the diffuser function is incorporated into the holographic features, such that the diffusing and light redirection functions are performed by the same optical component 805. This arrangement can simplify the structure of the display device, reduce component count and realize cost savings on manufacture. A single optical element 805 configured to redirect and diffuse light can also decrease rainbow artifacts associated with a thin volume hologram.

In the illustrated implementation 800, the holographic optical element 805 is disposed on a first side of a substrate 407 and the display element 101 is disposed on a second side of the substrate 407. Light from the first side is incident on the holographic optical element 805 at a non-normal angle with respect to a normal to a surface of the holographic optical element 805. The incident non-normal light is redirected by the holographic optical element 805 along a direction that is near normal with respect to a surface normal. The redirected light is also diffused at the same time by the holographic optical element 805. Although, in the illustrated implementation 800, the holographic optical element 805 and the display element 101 are disposed on opposite sides of the substrate. In other implementations, the holographic optical element 805 can be disposed directly over the display element 101.

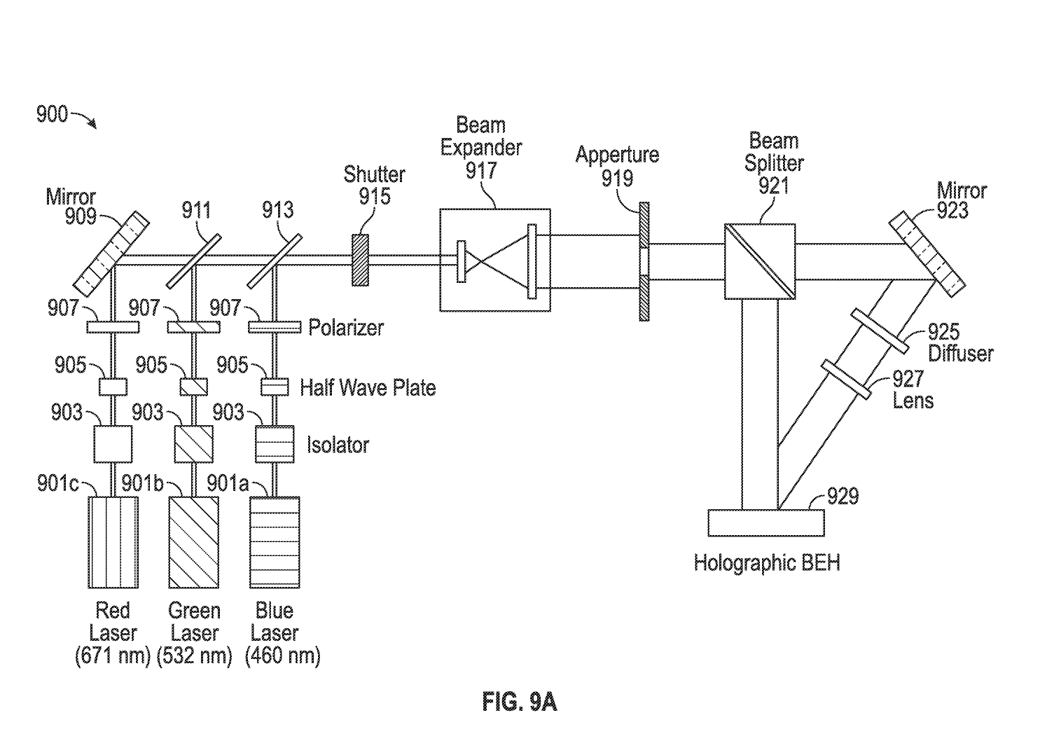

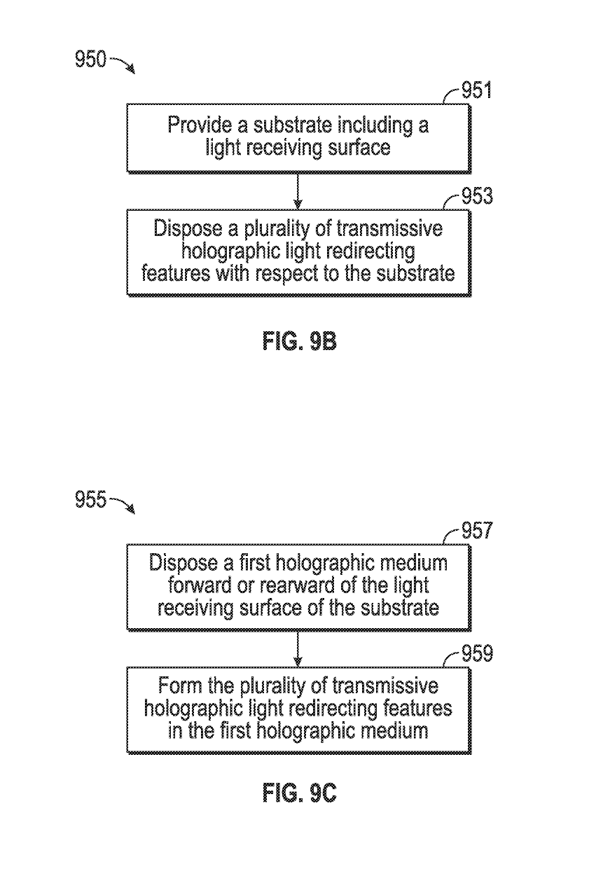

The diffuser functions can be incorporated in the hologram by placing diffusers when recording the holograms. FIG. 9A illustrates a system 900 that can be used to record holographic light redirectors that also function as a diffuser. The system of FIG. 9A can be used to record a white light brightness enhancement hologram that incorporates a diffuser function. The illustrated system 900 include a first light source 901a configured to output light in a first wavelength range, a second light source 901b configured to output light in a second wavelength range and a third light source 901c configured to output light in a third wavelength range. In various implementations, the three different light sources 901a, 901b and 901c can be lasers having wavelengths in the red (R), green (G) and blue (B) wavelength regions. Utilizing three different light sources 901a, 901b and 901c in three different wavelength ranges can be beneficial to simutaneously record multi-wavelength holograms (e.g., white light holograms). The light output from each of the different light sources 901a-901c can be conditioned by using optical components such as, a half-wave plate 905 and/or a polarizer 907. In various implementations, an isolator 903 can be disposed at the output of one or more of the light sources 901a-901c to prevent destabilization of the laser output due to reflections. The light output from each of the different light sources 901a-901c is combined using a combination of a mirror 909 and beamsplitters 911 and 913 to generate a combined multi-wavelength beam. A shutter 915 can be disposed in the optical path of the combined multi-wavelength beam to control exposure of the holographic medium 929. The spot size of the combined multi-wavelength beam can be tailored to a desired value by using a combination of a beam expander 917 and an apperture 919. The combined multi-wavelength beam is incident on a beam splitter 921 that directs the combined multi-wavelength beam toward the holographic medium 929 along a first path that is normal to the holographic medium 929 and a second path that is at a non-normal angle to the holographic medium 929. The combined multi-wavelength beam incident on the holographic medium 929 along the first and the second optical path interfere and form interference fringes inside the holographic medium 929. In this manner a holographic light redirector that receives incident light at non-normal angle and redirects it at near-normal angles is recorded. In various implementations, the holographic medium 929 can include a photopolymer, a photorefractive material, a photoresist, etc.

To incorporate the diffusing function a diffuser 925 is provided in the second optical path as shown in the system 900. Although, in the illustrated implementation, the diffuser is disposed in the second optical path, in other implementations, the diffuser could be disposed in the first optical path or the first and second optical paths. An optional collimating lens 927 can be placed at a distance equal to the focal length of the lens 927 away from the diffuser 925 to increase the efficiency of the recording light efficiency and/or to increase diffraction efficiency. The holographic medium 929 can be rotated in a plane orthogonal to the normal to the surface of the holographic medium 929 to record holograms at different azimuthal angles. A hologram recorded in this manner combines light diffusion and brightness enhancement into a single component.

In various implementations, a master hologram can be recorded using two coherent multi-wavelength laser beams similar to the system depicted in FIG. 9A. The master hologram can be used to produce holograms using a hologram replication method. An implementation of a hologram replication method includes a single multi-wavelength laser beam (e.g., including red, green and blue wavelengths), a master hologram recorded and a hologram medium on which hologram is replicated. Accordingly, the hologram replication method can include a single coherent beam.

FIG. 9B is a flowchart that describes an implementation of a method 950 of manufacturing a light redirector including a plurality of transmissive holographic light redirecting features. The method 950 includes providing a substrate including a light receiving surface as shown in block 951. In various implementations, the substrate can be a transmissive substrate. The substrate can include a transmissive material, such as, for example, glass, plastic, polymer etc. In some implementations, the substrate can be rigid. In other implementations, the substrate can be flexible. The substrate includes a light receiving surface having a surface normal and is configured to receive near-collimated light from an incidence direction that is at an angle with respect to the surface normal.

The method 950 further includes disposing a plurality of transmissive holographic light redirecting features with respect to the substrate, as shown in block 953. The plurality of transmissive holographic light redirecting features can be disposed forward or rearward of the light receiving surface of the substrate.

FIG. 9C is a flowchart that describes an implementation of a method 955 of forming a plurality of transmissive holographic light redirecting features in a holographic medium. The method 955 includes disposing a first holographic medium forward or rearward of the light receiving surface of the substrate, as shown in block 957. The first holographic medium can include a photopolymer, a photorefractive material, a photoresist, etc. The first holographic medium can have a thickness between about 10 μm and about 100 μm. In other implementations, the first holographic medium can have a thickness between about 100 μm and about 1 mm. In various implementations, the first holographic medium can be disposed using physical or chemical deposition methods.

The method 955 further includes forming the plurality of transmissive holographic light redirecting features in the first holographic medium, as shown in block 959. In various implementations, the plurality of transmissive holographic light redirecting features can be formed using a coherent multi-wavelength beam and a master hologram as discussed above. In other implementations, the plurality of transmissive holographic light redirecting features can be formed using a system similar to the system 900 illustrated in FIG. 9A and discussed above. Other methods of manufacturing a holographic light redirector can also be used.

In various implementations, the first holographic medium can be used as the substrate thereby eliminating the need for a separate substrate. In various implementations, the plurality of transmissive holographic light redirecting features can be formed in the first holographic medium which is laminated to a surface of the substrate. In various implementations, the substrate can include the substrate supporting the display element.

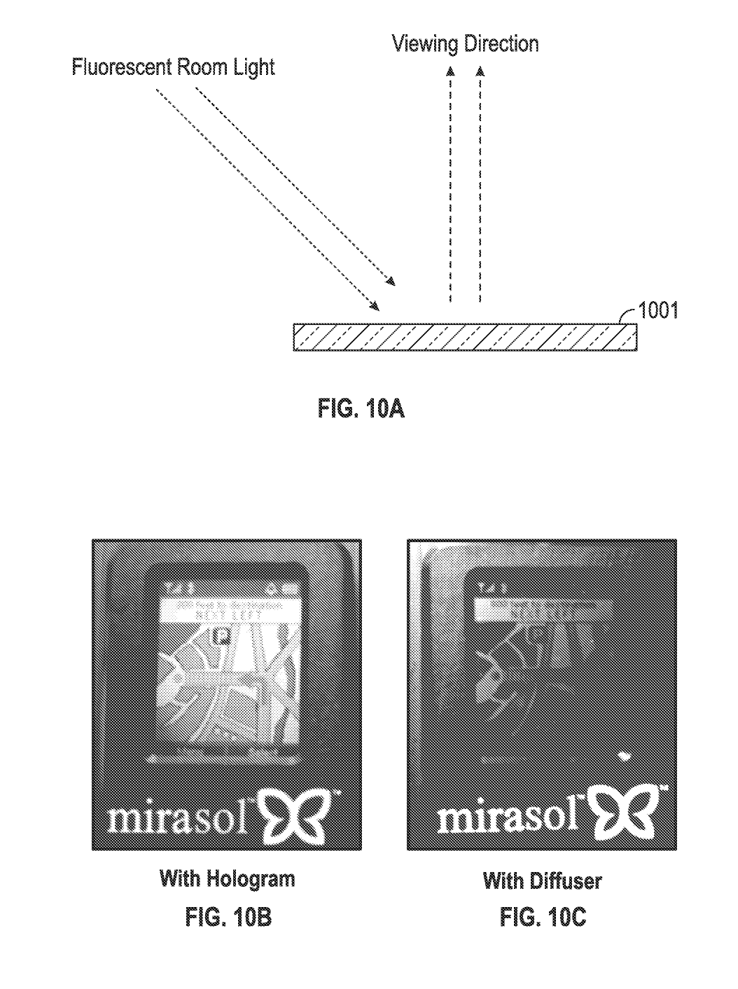

FIG. 10A illustrates an implementation of a display panel 1001 illuminated by a fluorescent light. In various implementations, the display panel 1001 can include a plurality of display elements 101. In various implementations, the display panel can include a plurality of IMOD display elements described in detail with FIG. 11 below. FIG. 10B illustrates an image displayed by the display panel provided with holographic light redirectors optically coupled to a diffuser or a single holographic optical element that can redirect and diffuse light as discussed above. FIG. 10C illustrates an image displayed by the display panel provided with a conventional diffuser with a haze value of 78. Light is incident on the display panel 1001 along a direction that is at an angle of about 45° with respect to a normal to the top surface of the display panel 1001 as illustrated in FIG. 10A. A camera (not shown) is provided along a direction normal to the top surface of the display panel 1001 to capture the view displayed by the display panel 1001. Comparing FIGS. 10B and 10 C, it is noted that the view from the display panel 1001 provided with holographic light redirectors optically coupled to a diffuser or a single holographic optical element that can redirect and diffuse light as discussed above is considerably brighter as compared to the view from the display panel 1001 provided with a conventional diffuser.

FIG. 11 is an isometric view illustration depicting two adjacent interferometric modulator (IMOD) display elements in a series or array of display elements of an IMOD display device. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of color primaries and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 11 includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage V₀ applied across the display element 12 on the left is insufficient to cause actuation of the movable reflective layer 14 to an actuated position such as that of the display element 12 on the right.

In FIG. 11, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be configured to be viewed from the opposite side of a substrate as the display elements 12 of FIG. 11 and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (e.g., chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (e.g., of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (Å).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 11, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 11. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

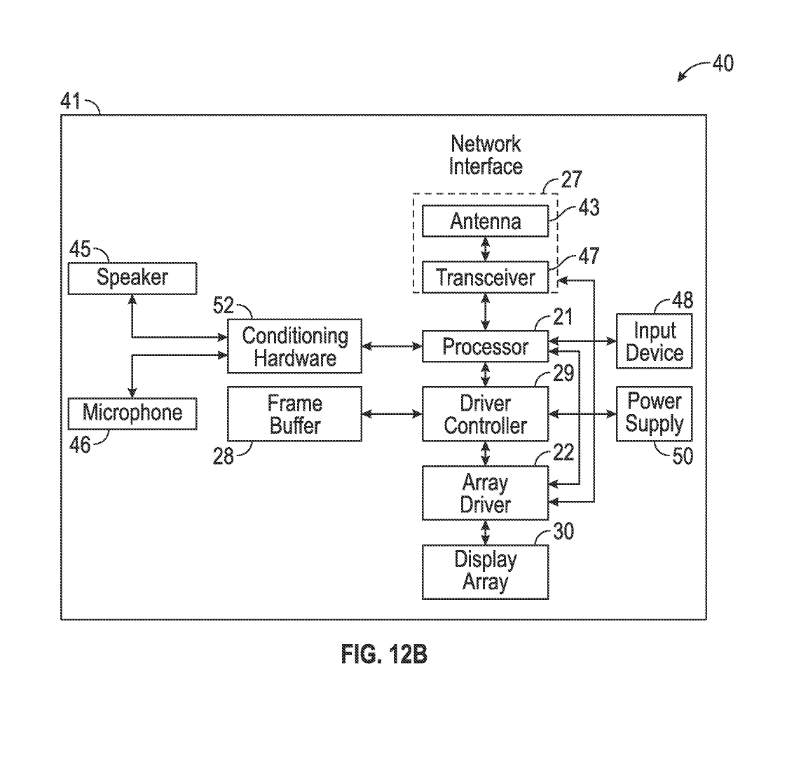

FIGS. 12A and 12B are system block diagrams illustrating a display device 40 that includes a plurality of IMOD display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD-based display, as described herein.

The components of the display device 40 are schematically illustrated in FIG. 12A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 12A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, e.g., an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A light redirector comprising:
a light receiving surface having a surface normal and configured to receive near-collimated light from an incidence direction that is at an angle with respect to the surface normal, and wherein a direction of specular reflection is associated with the incidence direction; and
a holographic layer including a plurality of transmissive holographic light redirecting features that are configured to redirect and diffuse the received light substantially along a direction that is within ±20 degrees with respect to the surface normal towards a side opposite the light receiving surface.

2. The light redirector of claim 1, wherein the incidence direction forms an angle between about 20 degrees and about 50 degrees with respect to the surface normal.

3. The light redirector of claim 1, wherein the holographic layer has a thickness between about 5 μm and about 50 μm.

4. The light redirector of claim 1, wherein the plurality of holographic light redirecting features are configured such that light incident from the side opposite to the light receiving surface in an angular range that is within ±10 degrees with respect to the surface normal is not redirected by the plurality of holographic light redirecting features.

5. The light redirector of claim 1, wherein the plurality of holographic light redirecting features include volume holograms.

6. A display device including the light redirector of claim 1 disposed over a reflective display element.

7. The display device of claim 6, wherein the reflective display element includes at least one interferometric modulator.

8. The display device of claim 6, wherein the reflective display element is disposed on a first side of a substrate and the light redirector is disposed on a second side of the substrate opposite the first side.

9. The display device of claim 6, further comprising:
a processor that is configured to communicate with the display, the processor being configured to process image data; and
a memory device that is configured to communicate with the processor.

10. The display device of claim 9, further comprising a driver circuit configured to send at least one signal to the display element.

11. The display device of claim 10, further comprising a controller configured to send at least a portion of the image data to the driver circuit.

12. The display device of claim 9, further comprising an image source module configured to send the image data to the processor.

13. The display device of claim 12, wherein the image source module includes at least one of a receiver, transceiver, and transmitter.

14. The display device of claim 9, further comprising an input device configured to receive input data and to communicate the input data to the processor.

15. The light redirector of claim 1, wherein the holographic layer functions as a light redirector and a light diffuser.

16. The light redirector of claim 1, wherein the holographic layer is a single optical element that is a light redirector and a light diffuser.

17. A light redirector comprising:
a light receiving surface having a surface normal and configured to receive near-collimated light from an incidence direction that is at an angle with respect to the surface normal, and wherein a direction of specular reflection is associated with the incidence direction; and
a layer including a plurality of transmissive means for holographically redirecting light, the transmissive light redirecting means configured to redirect and diffuse the received light substantially along a direction that is within ±20 degrees with respect to the surface normal towards a side opposite the light receiving surface.

18. The light redirector of claim 17, wherein the plurality of transmissive light redirecting means includes a plurality of transmissive holographic features.

19. The light redirector of claim 18, wherein the transmissive holographic features include volume holograms.

20. The light redirector of claim 17, wherein the layer is a single optical element that is a light redirector and a light diffuser.

21. A method of manufacturing a light redirector, the method comprising:
providing a substrate including a light receiving surface having a surface normal and configured to receive near-collimated light from an incidence direction that is at an angle with respect to the surface normal, and wherein a direction of specular reflection is associated with the incidence direction;
disposing a plurality of transmissive holographic light redirecting features with respect to the substrate, the plurality of transmissive holographic light redirecting features configured to redirect and diffuse the received light substantially along a direction that is within ±20 degrees with respect to the surface normal towards a side opposite the light receiving surface.

22. The method of claim 21, wherein disposing a plurality of transmissive holographic light redirecting features further comprises:
disposing a first holographic medium forward or rearward of the light receiving surface; and
forming the plurality of transmissive holographic features in the first holographic medium.

23. The method of claim 22, wherein the first holographic medium includes a photopolymer.

24. The method of claim 22, wherein the plurality of transmissive holographic features is formed by replicating a plurality of holographic features included in a master hologram on the first holographic medium using a single coherent multi-wavelength laser beam.

25. The method of claim 24, wherein the master hologram including the plurality of holographic features is recorded using two coherent laser beams incident on a second holographic medium, the two beams including multiple wavelengths in blue, green and red spectral regions.

26. The method of claim 25, wherein a diffuser is disposed in the optical path of one of the two beams.

27. The method of claim 25, wherein the plurality of holographic light redirecting features are recorded with one of the coherent laser beams being incident on the second holographic medium at different azimuthal angles.
